(19) United States
(12) Patent Application Publication
(10) Pub. No.: US 2007/0036324 A1
(43) Pub. Date: Feb. 15, 2007

(54) Apparatus and methods for providing a virtual remote print unit

(76) Inventors: Martin Harnois, Temecula, CA (US); Robert N. Painter, San Diego, CA (US); Jeffrey A. Wittek, Temecula, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/181,378

(22) Filed: Jul. 14, 2005

(51) Int. Cl. H04M 7/00

(52) U.S. Cl. 379/220.01

(57) ABSTRACT

A flexible computer-telephony integration system (CTI) that is able to communicate in both digital and analog formats is disclosed. Apparatus and methods are disclosed wherein data is received in a digital format, formatted for a particular receiving device including serial devices and digital devices, and communicated over an appropriate communication link depending on the formatting including a dedicated serial link, a PSTN or a packet switched network (LAN/WAN). Embodiments provide the ability to selectively communicate to both analog and digital recipients various types of emergency information, including but not limited to teletypewriter (TTY) data, call notes, supplemental information, and call history for both an active 9-1-1 call and previous 9-1-1 calls. Exemplary embodiments for 9-1-1 call processing systems are described.

### BACKGROUND OF THE INVENTION

1. Field of the Invention

The invention generally relates to the field of telecommunications control. More specifically, this invention relates to a computer-telephony integration system (CTI) that is able to communicate in both digital and analog formats.

2. Description of the Related Art

In general, CTI is the integration of computer and telephone systems. For example, CTI enables computers to know about and control telephony functions, such as making and receiving voice, fax, and data calls, telephone directory services, and caller identification. CTI systems provide enhanced capability and flexibility to pass data from a telephone network to a workstation for the purposes of obtaining data and properly routing telephone calls. CTI systems provide an important interconnection between voice and data in order to provide efficient and improved communication.

CTI was first commercialized in the 1970's to provide remote control of PBX systems for mainframe computers. This CTI communication environment was typically analog where information could be transmitted over dedicated data circuits to serial devices, such as printers and terminals, at remote locations.

In the 1990s, personal computer technology and digital communication was integrated into CTI devices, thereby providing more accessible solutions for telecommunications. Now, CTI devices provide many different functions and a better way to interface with several types of communication protocols, devices and systems, including the ability to transmit information and data to a remote location via Transmission Communication Protocol (TCP)/Intemet Protocol (IP) over a packet switched network facility.

There remains, however, a need for a CTI system that is able to communicate in the modern digital environment as well as the older analog environment. This is especially true in the emergency 9-1-1 network, where there are dedicated serial links between Primary Public Safety Answering Point (PSAP(s)) and the remote emergency response agencies that respond to emergency calls, but where there are also systems using the more current packet switched retrieval facilities. There also remains a need for the ability to communicate to both digital and analog devices while utilizing the functionality provided by CTI systems. Another need that remains is the ability to selectively communicate to both analog and digital recipients various types of emergency information, including but not limited to teletypewriter (TTY) data, call notes, supplemental information, and call history for both an active 9-1-1 call and previous 9-1-1 calls. To fulfill these needs, embodiments of the invention provide apparatus and methods that are able to convert between and communicate in both digital format (e.g., TCP/IP) and analog format (e.g., serial devices), are able to provide the functionality of a CTI system, and are able to selectively communicate to both analog and digital recipients various types of emergency information.

### SUMMARY OF THE INVENTION

The system, method, and devices of the invention each have several aspects, no single one of which is solely responsible for its desirable attributes. Without limiting the scope of this invention, its more prominent features will now be discussed briefly. After considering this discussion, and particularly after reading the section entitled “Detailed Description of Certain Embodiments” one will understand how the features of this invention provide advantages over other communications systems.

In one embodiment, a CTI system is provided, the system comprising: a first device configured to transmit first digital data and first formatting instructions corresponding to the first digital data, wherein the first formatting instructions specify either digital or analog format; and a second device configured to receive the first digital data and first formatting instructions transmitted from the first device, the second device configured to format the first digital data according to the first formatting instructions.

In another embodiment, a method of transmitting data is provided, the method comprising: receiving data at a computer-telephony integrated (CTI) client that is transmitted from a communication source; transmitting the data and formatting instructions for the data from the CTI client to a CTI server, wherein the formatting instructions comprise a particular format, the particular format comprising either analog or digital format; formatting the transmitted data into the particular format; and transmitting the formatted data to a remote device, wherein the remote device is at a location separate from the CTI client and CTI server.

In another embodiment, an apparatus for communicating data within a telecommunication system is provided, the apparatus comprising: means for receiving data in a digital format; means for formatting the data pursuant to formatting instructions; and means for transmitting the formatted data to a remote device.

In another embodiment, a method of communicating data within a telecommunication system is provided, the method comprising: receiving first data at a first device; retrieving second data at a second device, wherein the first data corresponds to the second data and the second data comprises formatting instructions, wherein the formatting instructions specify either digital or analog format; transmitting the first and second data to a third device; formatting the first data with the third device, wherein the first data is formatted into a format corresponding to the formatting instructions of the second data; and transmitting the formatted data to a fourth device.

In another embodiment, a method of communicating within a 9-1-1 communication system is provided, the method comprising: receiving 9-1-1 information at a central office; deciding an appropriate routing for the 9-1-1 information; selecting at least a portion of the 9-1-1 information for routing to a response agency; sending the selected portion of the 9-1-1 information to an output device; formatting into a transmission type the selected portion of the 9-1-1 information at the output device, wherein the transmission type corresponds to at least one communication device at the response agency; and transmitting in the transmission type the formatted 9-1-1 information to the at least one communication device at the response agency.

### BRIEF DESCRIPTION OF THE DRAWINGS

FIG. 1 is a block diagram illustrating an exemplary 9-1-1 call system.

FIG. 2 is a block diagram illustrating an exemplary 9-1-1 call system utilizing a Virtual Remote Print Unit (VRPU).

FIG. 3 is a flow chart illustrating an exemplary method utilizing a VRPU.

FIG. 4 is a flow chart illustrating an exemplary method that communicates and converts between digital and analog formats.

FIG. 5 is a block diagram illustrating an exemplary 9-1-1 communication system in accordance with embodiments of the invention.

FIG. 6 is a flow chart illustrating an exemplary method utilizing the exemplary 9-1-1 communication system of FIG. 5.

### DETAILED DESCRIPTION OF EMBODIMENTS OF THE INVENTION

The following detailed description is directed to certain specific embodiments of the invention. However, the invention can be embodied in a multitude of different ways. In this description, reference is made to the drawings wherein like parts are designated with like numerals throughout.

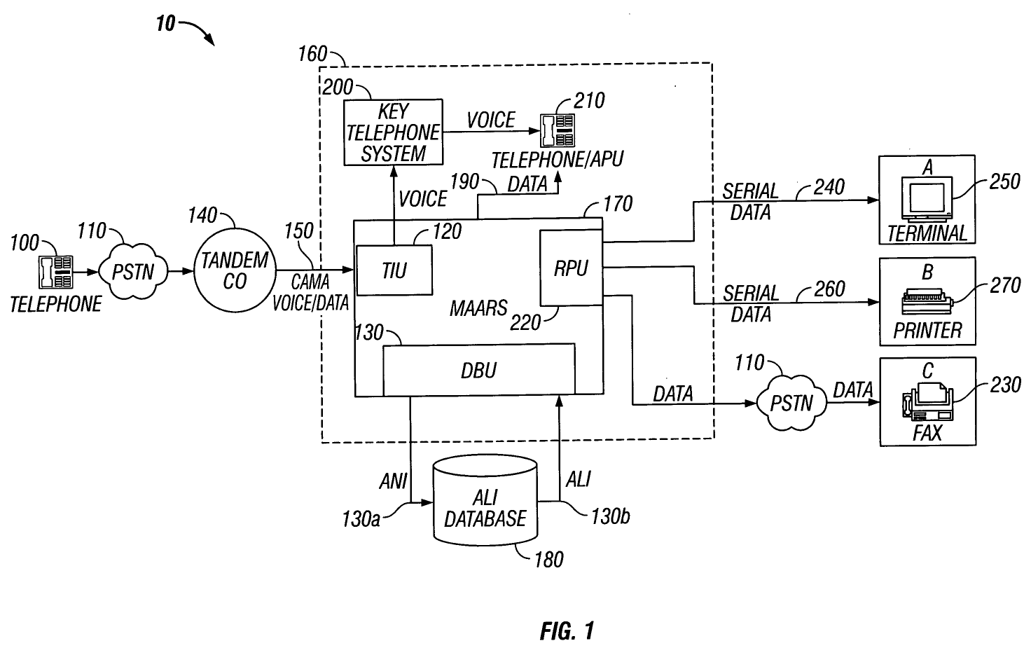

With reference to FIG. 1, a brief description of an emergency 9-1-1 system 10 is provided. When a person makes a 9-1-1 call at a communication device 100, both voice and data are transmitted via a publicly switched telephone network (PSTN) 110. Typically, the phone company servicing a particular communication device transmits an automatic number identification (ANI) signal to the PSTN 110. An embodiment of this ANI signal may comprise 8 digits, including seven digits for a phone number and an eighth digit that is shorthand for an area code. Alternatively, the ANI may comprise 10 digits, including a three digit area code and a seven digit phone number, or it may comprise 20 digits including a 10 digit key used to retrieve ALI and a 10 digit phone number used to call back the caller. Originally, ANI signaling was designed to assist the phone company in assessing toll charges for long distance calls. Now, in one application, ANI is utilized to relay important information regarding the originating source of an emergency 9-1-1 call.

Once the emergency 9-1-1 call is made, the voice and ANI data is transmitted through the PSTN 110, typically via a common channel signaling system No.7 (SS7), to a tandem central office (CO) 140 (also known as a 9-1-1 control office). This tandem CO 140 delivers the voice and ANI data, via a centralized automatic message accounting trunk (CAMA) 150, to a public safety answering point (PSAP) 160.

The PSAP 160 is a facility equipped and staffed to receive 9-1-1 calls. Typically, the PSAP 160 includes a controller 170 that performs, among other things, a retrieval of the physical address of the communication device 100 using the ANI data. The physical address information is also known as automatic location information (ALI) and is stored in a 9-1-1 ALI database 180. The controller 170 is depicted here as a Modular ANI/ALI Retrieval System (MAARS) that is manufactured by and commercially available from Plant Equipment, Inc. The MAARS unit 170 is able to transmit to a 9-1-1 ALI database 180 the ANI data from a 9-1-1 call and receive from the 9-1-1 ALI database 180 the corresponding ALI data, including the physical address of the communication device 100. In one embodiment, the 9-1-1 database may be a standard database having a set of ANI records with pointers to corresponding ALI data. The 9-1-1 ALI database 180 may or may not be part of the PSAP 160. FIG. 1 depicts the 9-1-1 ALI database 180 as being outside the PSAP 160.

The MAARS unit 170 is also capable of separating the voice and data from the incoming signal transmitted from the CAMA 150 for delivery to a plurality of destinations. The MAARS unit 170 separates the voice and data by communicating them on separate communication lines. For example, the MAARS unit 170 transmits the ALI and/or ANI data via a communication link 190 to a communication device within the PSAP 160, such as an answering position unit (APU) 210. The MAARS unit has a MAARS Trunk Interface Unit (TIU) 120 that terminates at the CAMA trunk 150. The TIU 120 provides signaling required to instruct the tandem CO 140 to transmit ANI data to the TIU 120, where the TIU 120 decodes the ANI data. The TIU 120 then sends the ANI data to a MAARS Data Base Unit (DBU) 130. The DBU 130 provides the ANI data to the 9-1-1 ALI database 180 via a line 130a, the ALI data corresponding to the ANI data is identified, after which the DBU 130 receives the corresponding ALI data from the 9-1-1 ALI Database 180 via line 130b. The ALI data may then be transmitted from the MAARS unit 170 to the APU 210 via a local area network 190.

The MAARS unit 170 is also able to separately transmit the voice data via a communication line, such as telephone system 200, to the APU 210. In particular, the TIU 120 of the MAARS unit 170 is connected to a telephone system 200 (typically Comcentrex (CCX)). The telephone system 200 is also connected to the APU 210. This allows voice data to be communicated from the TIU 120 of the MAARS unit 170 to the APU 210 via the telephone system 200.

Typically, a 9-1-1 dispatcher is located at the APU 210 within the PSAP 160. The dispatcher in the PSAP 160 does not have to gather the location or callback information from a person calling 9-1-1. This is because the dispatcher in the PSAP 160 is able to access the ANI and/or ALI information that is transmitted to the MAARS unit 170.

The ability of the MAARS unit 170 to communicate the data to remote response agencies via a dedicated serial link or the PSTN is depicted in FIG. 1. For example, the MAARS unit 170 may communicate via serial line 240 to a terminal 250 at response agency A or communicate via serial line 260 to a printer 270 at response agency B or communicate via the PSTN 110 to a fax machine 230 at response agency C. Typically, serial lines 240 and 260 are dedicated serial lines that use analog communication. The data transmitted by the RPU 220 over the PSTN 110 is also in analog format. Accordingly, the data communicated from the MAARS unit 170 to the response agencies A, B, or C may be received by a serial or analog device such as a printer, fax or computer terminal linked to a serial or analog communication port.

The dispatcher at the APU 210 may initiate a remote transfer, which triggers a MAARS Remote Print Unit (RPU) 220 to gather the appropriate data for the corresponding 9-1-1 call, including the ANI and ALI data, as well as other data such as call notes that may have been entered by the dispatcher or TTY data. The RPU 220 then formats the data using a published data format (published in the MAARS RPU documentation). If a dial-up serial connection is used the RPU 220 dials the end point, transmits the data, and disconnects the connection. If a permanent serial connection is used, the RPU 220 transmits the data. If a fax connection is sued, the RPU 220 dials the remote fax machine over the PSTN 110, transmits the data (using a standard fax protocol), and disconnects.

The MAARS unit 160 depicted in FIG. 1 is limited, however, because the RPU 220 is a hardware device that is not configured to communicate over a packet switched network, such as a local area network (LAN) or a wide area network (WAN). Rather, the RPU 220 may only communicate to remote sites over dedicated serial links 240 and 260 or in an analog format over the PSTN 110.

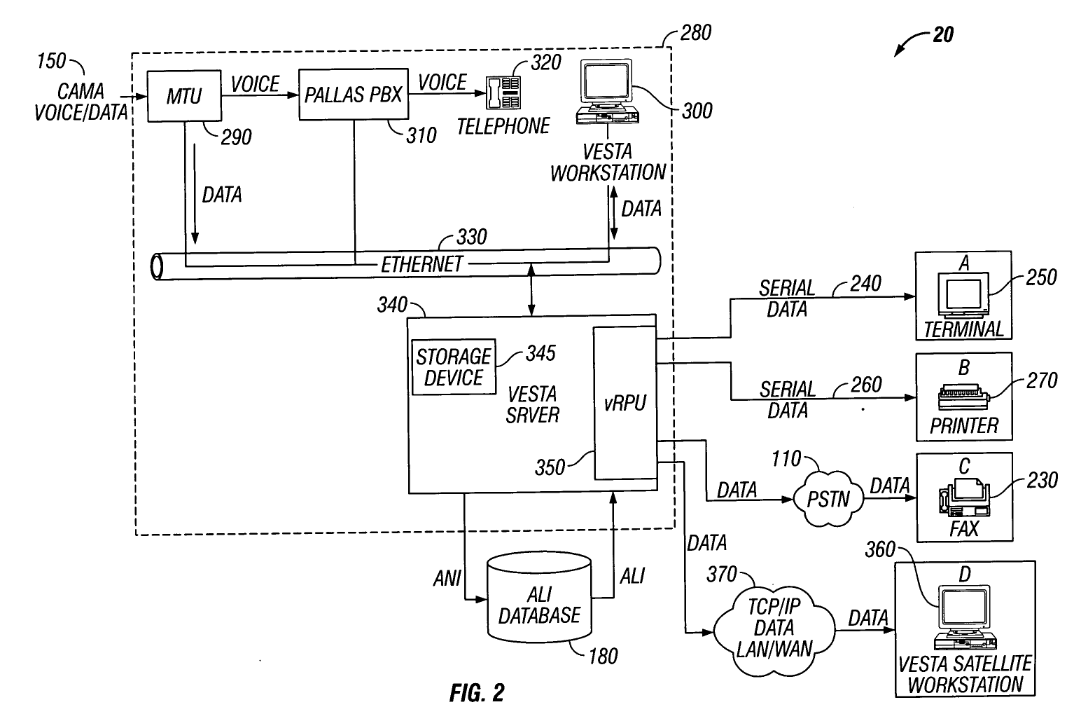

With reference to FIG. 2, an improved emergency 9-1-1 system 20 is depicted, where a Virtual Remote Print Unit (VRPU) 350 is configured to communicate data in a variety of desirable formats through a variety of desirable communication facilities. In this embodiment, the VRPU 350 may communicate to analog devices at remote sites A and B over dedicated serial links 240 and 260 respectively, to an analog device at remote site C over the PSTN 110, to remote site D over a packet switched network 370 (LAN/WAN), and to local digital devices through an Ethernet/LAN.

In this embodiment, the improved 9-1-1 system 20 has a PSAP 280 with a Master Terminal Unit (MTU) 290 that terminates at the CAMA trunk 150, such that the MTU 290 receives voice and ANI data relating to a 9-1-1 call. The MTU 290 provides signaling required to instruct the tandem CO 140 (depicted in FIG. 1) to transmit ANI data to the MTU 290, where the MTU 290 decodes the ANI data. The MTU 290 is capable of separating the voice and ALI data from the incoming signal transmitted from the CAMA 150 for delivery to a plurality of destinations.

For delivery of the voice data, the MTU 290 is connected to a private PBX system 310, depicted here as a Pallas PBX that is manufactured by Nortel and is commercially available from Plant Equipment, Inc. The Pallas PBX 310 has a flexible and extensible architecture such that the particular structure of a particular Pallas PBX 310 is dependent on the actual environment of the PSAP 280 where the Pallas PBX 310 is used. The Pallas PBX 310 is also connected to a plurality of communication devices, including a telephone 320, which may receive the voice data. In one embodiment, the telephone 320 may communicate in either analog or digital format.

For processing and delivery of the ALI data, the MTU 290 is connected to an Ethernet/LAN 330 that is connected to a processing device 340, depicted here as a VESTA Server. The VESTA Server may be a typical server, such as those manufactured by Hewlett-Packard or Dell, and is commercially available from Plant Equipment, Inc. with specific software designed by Plant Equipment, Inc. depending on the particular needs of the specific CTI environment.

The MTU 290 sends the ANI data over the Ethernet 330 to the VESTA Server 340. The VESTA Server 340 then provides the ANI data to the 9-1-1 ALI database 180, after which the VESTA Server 340 receives the corresponding ALI data from the 9-1-1 ALI Database 180. The ALI data may then be transmitted from the VESTA Server 340 in a variety of formats over a variety of communication facilities.

The VESTA Server 340 first communicates the ALI data via the Ethernet 330 to a VESTA Workstation 300 within the PSAP 280. The VESTA Workstation 300 may be a typical workstation, such as those manufactured by Hewlett-Packard or Dell, and like the VESTA Server, the VESTA Workstation 300 is commercially available from Plant Equipment, Inc. with specific software designed by Plant Equipment, Inc. depending on the particular needs of the specific CTI environment.

After the VESTA Server 340 communicates the ALI data to the VESTA Workstation 300, a user at the VESTA Workstation 300 may view the ALI data corresponding to the voice data received at the telephone 320 from the active 9-1-1 call. Other types of data may also be communicated to the VESTA Workstation 300. For example, TTY data may be communicated from the MTU 290 to the VESTA Workstation 300 via the Ethernet 330. Moreover, the VESTA Server 340 may be configured with a storage device 345 that has other data corresponding to the ANI/ALI data of the active 9-1-1 call, including a call history, call notes, or other supplemental information. The storage device 345 may be a PEIDS Database, which is a standard sequel (SQL) database. The PEIDS Database is commercially available from Plant Equipment, Inc. with particular software designed by Plant Equipment, Inc. depending on the particular needs of the specific CTI environment.

Other data stored on the storage device 345 that may also be communicated to the VESTA Workstation 300 may include the call history of previous 9-1-1 calls having the same ALI or ANI data, the call notes entered by a 9-1-1 dispatcher on those previous calls, and supplemental information corresponding to the ANI/ALI data. The other data may also include data from 9-1-1 calls having different ANI or ALI data. This other data stored in the VESTA Server 340 along with the ALI data may then be communicated to the VESTA Workstation 300 via the Ethernet 330.

This data, including any portion of the TTY data, ALI data, ANI data, call history, call notes, and other supplemental information, may then be communicated by the VESTA Server 340 to a variety of remote sites via the VRPU 350. All of the data that is ultimately sent to a remote device is gathered by the VESTA Server 340 and sent to the VESTA Workstation 300 via the Ethernet 330 for viewing by a 9-1-1 call taker at the VESTA Workstation 300.

The 9-1-1 call taker at the VESTA Workstation 300 may initiate a remote transfer of data to a remote response agency. The call taker may select which data to send, including TTY data (if applicable), ANI/ALI data, call history, call notes, or other supplemental information. The call taker may also designate which remote agencies are to receive the remote transfer. The call taker also may select other features, such as autodial or other desired functionality for the remote transfer.

In one embodiment, the VESTA Workstation 300 is configured with an auto-dial feature. The auto-dial feature includes an auto-dial database of information corresponding to particular remote response agencies. For example, the auto-dial database may include data regarding contact information, necessary data format, and available communication facilities required to communicate with the particular remote response agency. The auto-dial database may also have information relating to the status of the communication devices of the remote response agency and information regarding previous remote transfers to that remote response agency.

A user may then select the desired remote response agency for the remote transfer and the auto-dial feature may automatically determine, for example, whether the data transferred should be in analog or digital format and what type of communication device is located at the remote response agency, such as a terminal, printer, fax, or workstation. In one embodiment, the auto-dial feature automatically selects all available devices at the remote response agency to receive the data selected by the 9-1-1 call taker at the VESTA Workstation 300. In another embodiment, the 9-1-1 call taker at the VESTA Workstation 300 may select which available devices at the remote response agency should receive the selected data.

In another embodiment, the VESTA Server 340 may be equipped with an auto-dial database. In yet another embodiment, the VESTA Workstation 300 and/or the VESTA Server 340 is configured with an auto-dial maintenance program where, for example, auto-dial information on the auto-dial database may be added, deleted or edited. In some embodiments, the auto-dial database may be a PEIDS database.

When the 9-1-1 call taker initiates a remote transfer, the VESTA workstation 300 gathers the data being displayed to the 9-1-1 call taker and sends it to the VESTA Server 340 using the Ethernet 330. The VRPU 350 within the VESTA Server 340 receives the remote transfer request from the VESTA Workstation 300, including the data selected for the remote transfer and the selected remote response agencies to receive the remote transfer. The VRPU 350 then identifies which remote devices are to receive the data and formats the data according to the configuration for each remote device selected. The VRPU 350 then manages the communication process with the remote device to ensure the data is delivered. For instance, if there are two simultaneous remote transfer requests to the same device, the VRPU 350 will queue the transfer requests and perform them in the order they were received. In some embodiments, the queue is designed and functions similarly to a typical printer queue. In one such embodiment, the transfer requests are stored and processed in the order received by the VRPU 350.

The VRPU 350 may also be configured to display an alarm to a user at the VESTA Workstation 300 that requested a remote transfer that was not properly transferred. For example, if a requested remote transfer is discarded because of a communication error or if the remote transfer remains in the queue for a time exceeding a maximum queue time, then the VRPU 350 or another program within the VESTA Server 340 may display an alarm displayed on the VESTA Workstation 300 where the remote transfer originated. The alarm may include details of the failed remote transfer, for example, if the communication device or communication facility at the requested remote response agency is not working properly.

When a remote transfer is initiated by a user at a VESTA workstation 300 for transfer of data to a remote response agency, the VRPU 350 is configured to receive the data and the remote transfer request in digital format, depicted in this embodiment as TCP/IP format, over an Ethernet/LAN 330. The VESTA Server 340 then manages the data in a digital format. The VRPU 350 is also configured to convert the data in digital format into analog format when necessary to communicate with a remote site using an analog device.

The conversion of the data by the VRPU 350 from digital to analog format may be made by any of the appropriate methods or algorithms known in the art. For example, in one embodiment, the conversion to analog may be performed by a modem if the VRPU 350 attempts to send the digital data via the PSTN 110 to a fax machine 230 at remote site C. In another embodiment, the data format in which data should be transmitted by the VRPU 350 to a printer or terminal device is based on the format that is used by the MAARS RPU 220 (depicted in FIG. 1). The following is an example of program logic that may be used by the VRPU 350 in this embodiment:
LINE 1: DC1
LINE 2: CR+LF+([CHARACTERS PER LINE]* ‘−’)+CR+LF
LINE 3: [CALL CENTER NAME]+‘’+“CON#nnn”+CR+LF
LINE 4: “Date/time stamp: YYYY/MM/DD hh:mm:ss”+CR+LF
LINE 5: [FORMATTED LOCATION INFORMATION]
LINE 6: CR+LF+CR+LF+“TTY:”+[TTY CONVERSATION]
LINE 7: CR+LF+CR+LF+Call Notes: “+[CALL NOTES]
LINE 8: CR+LF+([CHARACTERS PER LINE]* ‘−’)+CR+LF
LINE 9: [FORM FEED]
LINE 10: DC3

Line 3 is included if the Include the call center name and console ID parameter is enabled. Line 4 is included if the Include a date and time stamp parameter is enabled. Line 5 is included if the Location Information parameter is enabled and there is location information associated with the call. If the location information does not contain CR/LFs then add a CR+LF at every [LI CHARACTERS PER LINE] number of characters in the location information. If a CR is found without an LF then add an LF. Line 6 is included if the TTY parameter is enabled and there is TTY text associated with the call. Add a CR+LF at every [CHARACTERS PER LINE] number of characters in the TTY conversation. If a CR is found without an LF then add an LF. Line 7 is included if the Call Notes parameter is enabled and there are call notes associated with the call. Add a CR+LF at every [CHARACTERS PER LINE] number of characters in the call notes. If a CR is found without an LF then add an LF. Line 9 is included if the Send a form-feed after the data is sent parameter is enabled.

The data may be delivered by the VRPU 350 to the remote response agencies via one or more of the dedicated user circuits 240 and 260 coupled to the VESTA Server 340. These dedicated user circuits 240 and 260 are serial links, such as COM links, that are each connected to a separate remote response agency. For example, user circuit 240 is part of a serial link that is coupled to a terminal 250 at reponse agency A, wherein the VESTA Server 340 may communicate directly to the terminal 250 at response agency A in an analog format. Similarly, user circuit 260 is part of a serial link that is coupled to a printer 270 at response agency B, wherein the VESTA Server 340 may communicate directly to the printer 270 at response agency B in an analog format.

The data may also be delivered over a packet switched network, such as a LAN or WAN, from the VESTA Server 340 to a workstation device at a remote site. For example, the VRPU 350 may transmit the data via a packet switched network 370, which may be a LAN or a WAN using TCP/IP protocol, to a VESTA Satellite Workstation 360 at response agency D. The VESTA Satellite Workstation 360 can display all of the information in the same manner it is displayed at a VESTA Workstation 300 in the PSAP 280. Additionally, the VESTA Satellite Workstation may be configured with software that can use the ALI data to plot the location of the 9-1-1 caller on a map. An example of such software is MapStar, manufactured by Plant Equipment, Inc. and is commercially available as product no. 871399-00205.2 The MapStar software is configured to receive ALI data, parse the physical location information, and plot that location information on a map where the physical location may be viewed by a user.

In other embodiments with reference to FIG. 2, the PSAP 280 is configured to receive data, among other things, which may be in an analog or digital format. The PSAP 280 is then able to process that data into digital format, if it is not already in digital format, and communicate that digital data to a plurality of components within the PSAP, including but not limited to the VESTA Workstation 300, other workstations, an Ethernet 330, or a VESTA Server 340. The PSAP 280 may use commercially available software or hardware to convert data into digital format. For example, in some embodiments, an analog to digital (A/D) converter is used. In other embodiments, software is used that is configured with publicly or commercially available software that can convert data from digital to analog format and/or from analog to digital format.

With the ability to communicate via an Ethernet 330 in digital format, the PSAP 280 is able to communicate data to other workstations in the PSAP 280 or other communication devices coupled to the same Ethernet 330. This may include communication to other agencies coupled to the Ethernet 330 or the Internet via a router. For example, in other embodiments, the ANI and/or ALI data in digital format (e.g., TCP/IP) may be communicated from the PSAP 280 to a remote response agency if that remote response agency is communicatively coupled the PSAP 280 in a way that allows digital communication.

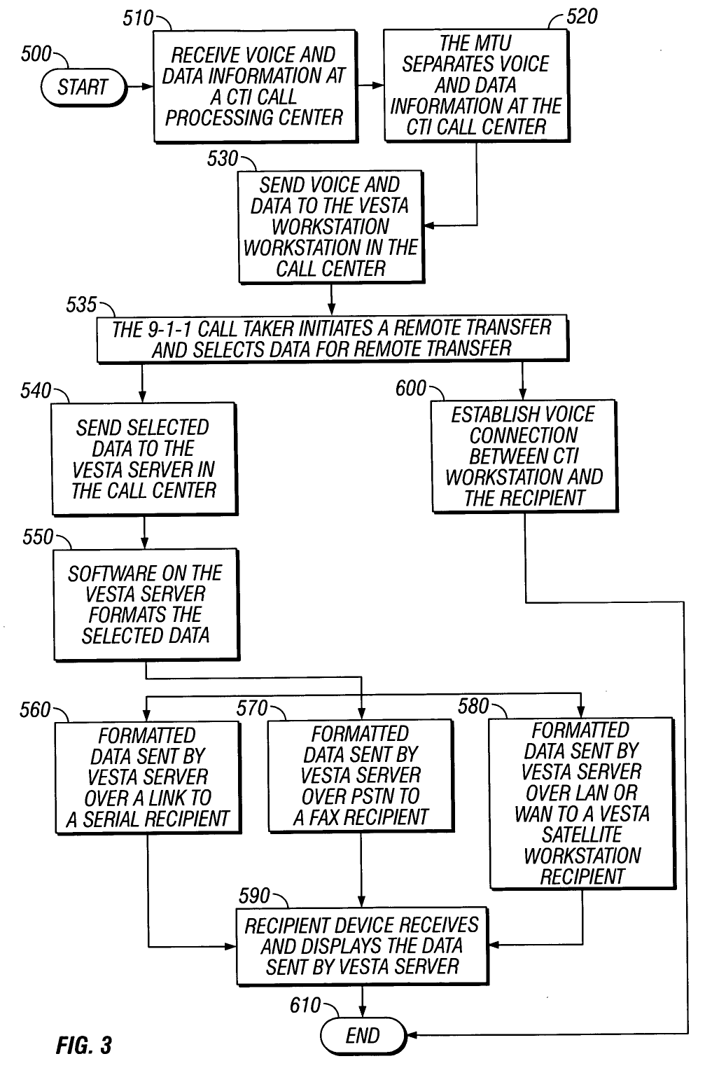

With reference to FIG. 3, a method of communicating data will be discussed. In the exemplary embodiment of FIG. 3, the method starts at state 500 and moves to state 510 wherein a CTI call center receives voice and data. At state 520 a processing unit within the CTI call center, such as a MTU, separates the voice and data and at state 530 sends the voice and data to a CTI workstation, such as a VESTA Workstation. Because the voice and data is separated at state 520 before it is sent to the CTI workstation, the voice and data may be sent via separate communication lines, each configured to communicate voice and/or data.

Once the voice and data is received at the CTI workstation, a user at the CTI workstation may add to the data. For example, in an exemplary embodiment, a user at a CTI workstation may receive ALI and/or ANI data from a 9-1-1 emergency call. The user at the CTI workstation may then add to those data specific facts regarding the emergency situation communicated from a caller. Moreover, the CTI workstation may add to the data contact information for a recipient, such as a remote response agency, where that recipient contact information may be used to communicate the emergency 9-1-1 call data to the remote response agency.

In state 535, the user at the CTI workstation initiates a remote transfer to a particular remote response agency or multiple agencies. The user may also select at state 535 what data is to be sent in the remote transfer. For example, if a TTY conversation takes place, the text of the TTY conversation can be sent in the remote transfer. Also, ALI data, ANI data, call history, call notes, or other supplemental information may be sent in the remote transfer.

In state 540, the CTI workstation sends the selected data in digital format via a LAN or WAN to software within a server. The software may be the VRPU and the server may be a VESTA Server. At state 550, the software formats the data such that it may be communicated to the particular remote response agency chosen by the user at the CTI workstation. Depending on the particular remote agency chosen as the recipient of the data, the data may be formatted into a serial format for receipt by a serial terminal or a serial printer over a dedicated serial circuit, or the data may be formatted into an analog format for receipt by a fax machine over a PSTN, or the data may be formatted into a digital format for receipt by a remote workstation over a LAN or WAN.

The VESTA Server may then communicate the formatted data to the chosen remote response agency. For example, at state 560, the VESTA Server may send formatted data over a link to a serial recipient; at state 570 the VESTA Server may send formatted data over a PSTN to a fax recipient; at state 580 the VESTA Server may send formatted data over a LAN or WAN to a workstation recipient, such as a VESTA Satellite Workstation.

At state 590, the recipient may then receive the data sent by the VESTA Server and display it via the receiving device, for example, a fax, printer, terminal or workstation. In other embodiments, monitoring algorithms may be added to the CTI workstation and/or VRPU wherein a state of the connection (including serial, analog, digital or PSTN connections), the remote device (including terminals, fax machines, printers, and workstations), or transmission properties of the data may be monitored. For example, if the device of the recipient or the link is not working properly, a message may be delivered to the user at the CTI workstation. During, before, or after transmitting the data to the recipient, a user at the CTI workstation may establish a voice connection with the recipient at state 600. The method then ends at state 610.

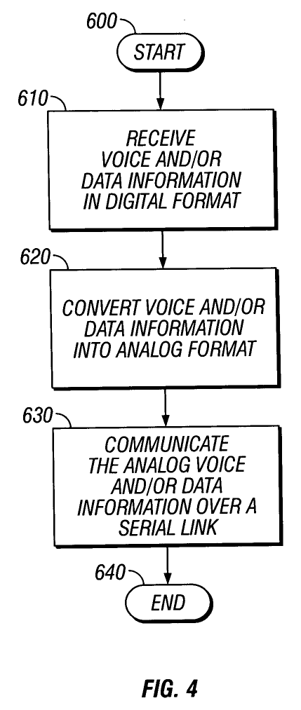

With reference to FIG. 4, an exemplary method of communicating information is disclosed. The method starts at state 600 and moves to state 610 wherein an apparatus receives voice and/or data in a digital format. Moving to state 620, the apparatus converts the voice and/or information into an analog format. At state 630, the apparatus communicates the analog voice and/or data via a serial link, after which the method ends at state 640.

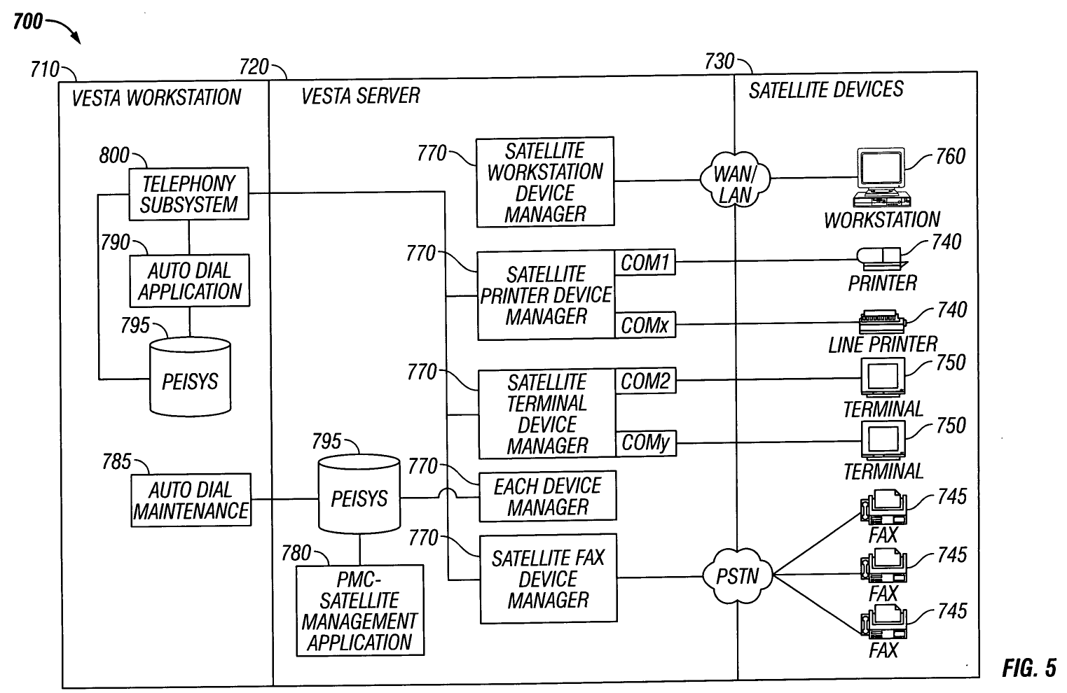

With reference to FIG. 5, an exemplary 9-1-1 communication system 700 is disclosed. In this 9-1-1 communication system 700, a VESTA Workstation 710 is communicatively coupled to a VESTA Server 720, and the VESTA Server 720 is communicatively coupled to a plurality of Satellite Devices 730. Although FIG. 5 depicts a single VESTA Workstation 710 and a single VESTA Server 720, multiple VESTA Workstations 710 and VESTA Servers 720 may be used in alternative embodiments.

A Satellite Device 730 is the term given to the equipment that is located at a remote site, such as a remote response agency, that will be used to view and interact with call information. For example if a printer 740 is installed in a volunteer fire station, the printer 740 would be referred to as a Printer Device 740. The Satellite Device 730 types that exist in the system are as follows:
Printer Device 740—a remote printer. The Printer Device 740 can display calling number, location information, call notes, and/or TTY information. Printer Devices 740 are also at times referred to as Printer Ports.
Fax Device 745—a remote fax machine. The Fax Device 745 can display calling number, location information, call notes, and/or TTY information.
Terminal Device 750—a remote display terminal (i.e. a “dumb” terminal). The Terminal Device 750 can display calling number, location information, call notes, and/or TTY information. Terminal Devices 750 are also at times referred to as Terminal Ports.
Workstation Device 760—a Satellite VESTA workstation. The Workstation Device 760 is a computer running a limited version of VESTA that can display calling number, location information, supplemental location information, and call history. Additionally the location information can be passed to MapStar and displayed on a map.

Each type of Satellite Device 730 is managed by a corresponding Satellite Device Manager 770 within the VESTA Server 720. The Satellite Device Manager 770 is a computer program stored on the VESTA Server 720 that receives transmission requests from VESTA Workstations 710. The Satellite Device Manager 770 receives the transmission requests, queues them if necessary, and ultimately delivers the 9-1-1 call information using the communication and display configuration appropriate for the particular Satellite Device 730 to receive the transmission.

A Satellite Device Manager 770 for either a Printer Device 740 or a Terminal Device 750 communicates with the Printer Device 740 or Terminal Device 750 using a COM port accessible from the VESTA Server 720. The COM port may be attached to a modem that provides a dedicated connection to a modem at the Printer Device 740 or the Terminal Device 750. The modem configuration allows a data transfer to reach printers or terminals installed anywhere a within reach of a dedicated analog circuit. Messages are sent from the Satellite Device Manager 770 to the corresponding Printer Device 740 or Terminal Device 750 to provide notification of the call information related to the data transfer. The Printer Device 740 or Terminal Device 750 can then display the data transferred, which typically includes the 9-1-1 call information. The Printer Device 740 may display the transferred data in a print-out and the Terminal Device 750 may display the transferred data on a screen.

A Satellite Device Manager 770 for a Fax Device 745 communicates with the Fax Device 745 using a modem accessible from the VESTA Server 720 and the PSTN. The modem configuration allows a data transfer to reach a Fax Device 745 communicatively coupled to the PSTN. The Satellite Device Manager 770 dials the particular Fax Device 745 desired for a data transfer and transfers the data to the Fax Device 745. The Satellite Device Manager 770 uses appropriate communication parameters for the particular Fax Device 745. The Fax Device 745 can then display the data transferred, which typically includes the 9-1-1 call information, in a print-out.

A Satellite Device Manager 770 for a Workstation Device 760 communicates with the Workstation Device 760 using a TCP/IP enabled network, either LAN or WAN, such as a WAN or LAN, accessible from the VESTA Server 720. The TCP/IP configuration allows a data transfer to reach a Workstation Device 760 communicatively coupled to the WAN/LAN. The Satellite Device Manager 770 accesses the particular Workstation Device 760 desired for a data transfer, sends a message to the Workstation Device 760 to notify the Workstation Device 760 of the 9-1-1 call information related to the data transfer, and then transfers the data to the Workstation Device 760. The Satellite Device Manager 770 uses appropriate communication parameters for the particular Workstation Device 760. The Workstation Device 760 can then display the data transferred, which typically includes the 9-1-1 call information, on a screen. Additionally location information transferred to the Workstation Device 760 can be passed to a mapping program, such as MapStar, and displayed on a map on the Workstation Device 760.

The Satellite Device Manager 770 will also monitor the status of the communication channel between the VESTA Server 720 and the Satellite Device 730. For example, the Satellite Device Manager 770 may be configured to display a variety of alarms and system messages. These may include alarms and/or system messages that monitor and report on data transmission between the VESTA Server 720 and the Satellite Device 730, communication port status, and Satellite Device 730 status. The Satellite Device Manager 770 may also be configured to disable a particular Satellite Device 730 if the Satellite Device 730 is not properly communicating or is otherwise off-line. Once the particular Satellite Device 730 begins to properly communicate or is otherwise on-line, the Satellite Device Manager 770 may be configured to then enable that particular Satellite Device 730 for communication with the VESTA Server 720.

In order to send data to a Satellite Device 730, the VESTA Server 720 must be configured to communicate with the Satellite Device 730 over the appropriate communication facility. A Satellite PMC Management Application 780 stored on the VESTA Server 720 provides the configuration items required to configure the VESTA Server 720 to communicate with the Satellite Devices 730 whether they are printers, terminals, or workstations, over the appropriate communication facilities whether they are COM links, a WAN/LAN, or a PSTN. The Satellite PMC Management Application 780 also provides the tools required to monitor or change the state of each of the Satellite Devices 730 or the communication facilities.

In one embodiment, a transfer of data to a Satellite Device 730 may be initiated by an Auto-Dial Application 790 stored on a VESTA Workstation 710. The Auto-Dial Application 790 has access to a plurality of Auto-Dial Entries, where each Auto-Dial Entry is configured with communication parameters for at least one Satellite Device 730. These communication parameters can include the particular type of Satellite Device 730, the appropriate format for communication to the particular Satellite Device 730, and the appropriate communication channel communicatively coupled to the particular Satellite Device 730. The Auto-Dial Entries may be stored on a database, such as a PEIDS database 795, that is communicatively coupled to the Auto-Dial Application 790 and a Telephony Subsystem 800. The Auto-Dial PEIDS database 7956 may be stored on the VESTA Workstation 710 or the VESTA Server 720.

Once a VESTA Workstation 710 initiates a transmission of data to a Satellite Device 730 using the Auto-Dial Application 790, the Auto-Dial Application 790 will identify the Dial Entry that was selected for the particular Satellite Device(s) 730. The Dial Entry information is then communicated to a Telephony Subsystem 800, which is communicatively coupled to each Satellite Device Manager 770. The Telephony Subsystem 800 determines the appropriate action or actions to take for the corresponding Auto-Dial Entry. The Telephony Subsystem 800 must then gather the appropriate 9-1-1 call information, including the appropriate communication parameters, and send the 9-1-1 call information and communication parameters to the selected Satellite Device Manager(s) 770 on the VESTA Server 720. Moreover, the Telephony Subsystem 800 is configured to establish a voice connection, if desired, with the remote response agency of the selected Satellite Device 730. For example, a user at the VESTA Workstation 710 may direct the Telephony Subsystem 800 to establish a voice connection between a telephone accessible to the user and a telephone at the desired remote response agency where a data transfer of 9-1-1 call information is to be communicated to the desired Satellite Device 730.

The Telephony Subsystem 800 then communicates to the appropriate Satellite Device Manager 720 the 9-1-1 call information to be transferred and the communication parameters for the particular Satellite Device 730. The Satellite Device Manager 770 receives the transmission requests from the Telephony Subsystem 800, queues them if necessary, and ultimately delivers the 9-1-1 call information using the communication and display configuration appropriate for the particular Satellite Device 730 to receive the transmission.

The 9-1-1 communication system 700 depicted in FIG. 5 may also be configured with an Auto-Dial Maintenance 785 feature. The Auto-Dial Maintenance 785 feature may be a computer program stored on a VESTA Workstation 710 that is communicatively coupled to the Auto-Dial PEIDS Database 795 such that the Auto-Dial Maintenance 785 program may store, retrieve, delete, and edit Auto-Dial Entries, including Auto-Dial configurations for each Satellite Device 730 that is defined for the Dial Entries. The Auto-Dial Maintenance 785 program may also be configured to store, retrieve, delete, and edit specific data transfers to a Satellite Device 730. For example, the Auto-Dial Maintenance 785 program may be used to add, delete, edit or configure a new or existing request for a transfer of data to a Satellite Device 730. A log may also be generated by the Auto-Dial Maintenance 785 program that reports the status of requested data transfers and the status of the Satellite Devices 730 and the communication lines between the Satellite Devices 730 and the VESTA Server 720.

The 9-1-1 communication system 700 depicted in FIG. 5 may also be configured with a Satellite PMC Management Application 780 that can read, write, and edit configuration information for the Device Managers 770 and Satellite Devices 730 from and to the Auto-Dial PEIDS Database 795. For example, a Satellite Device 730 may be deleted, added, or configured using Satellite PMC Management Application 780 with the updated information stored to the Auto-Dial PEIDS Database 795 by the Satellite PMC Management Application 780. A status report for each Satellite Device 730 may also be generated by the Satellite PMC Management Application 780. Also, in one embodiment, a limited version of the Satellite PMC Management Application 780 is installed on the Satellite Workstation Device 760. The limited version of the Satellite PMC Management Application 780 at least allows the Satellite Workstation Device 760 to be configured according to a desired set of communication parameters.

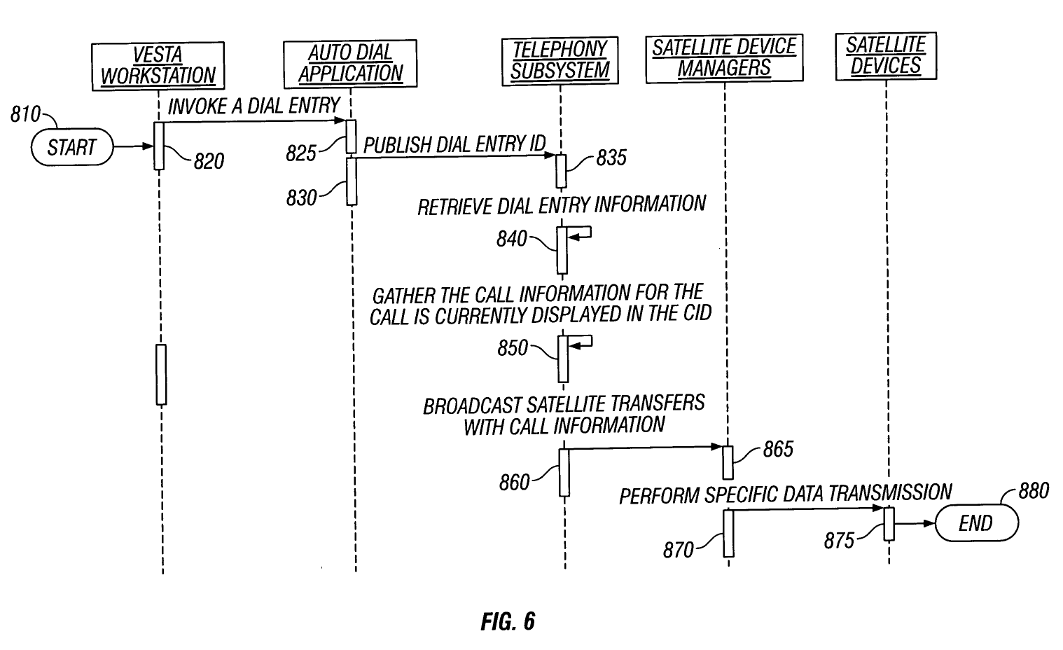

Referring now to FIG. 6, a flow chart illustrates an exemplary method of utilizing the exemplary 9-1-1 communication system 700 of FIG. 5. The method starts at state 810 with the receipt of a 9-1-1 call and moves to state 820 wherein a VESTA Workstation 710 invokes a Dial-Entry within the Auto-Dial Application 790. The Dial-Entry may include an identification of a specific Satellite Device 730 at a remote response agency to receive a remote transfer of data corresponding to a 9-1-1 call. The Dial-Entry may also include a command to transfer other data to the remote response agency, including call notes, call history, TTY, and supplemental data.

State 820 may be triggered by a user at the VESTA Workstation 710 or may be triggered automatically by a program configured to respond to 9-1-1 emergency calls. In one embodiment, an automatic triggering of state 820 may be accomplished by a program installed on the VESTA Workstation 820 or VESTA Server 720, where the program receives the 9-1-1 call, the ANI and/or ALI data associated with the call, and any other supplemental information available, such as a keyed selection by the 9-1-1 caller that identifies a specific type of emergency service desired.

At state 825 the Auto-Dial Application 790 receives the Dial-Entry communication from the VESTA Workstation 710 and at state 830 the Auto-Dial Application 790 publishes to the Telephony Subsystem 800 a Dial-Entry Identification corresponding to the Dial-Entry. The Dial-Entry Identification may correspond to a specific entry on the Auto-Dial Database 795 where the Satellite Device 730 configuration information, status, and other desirable Satellite Device 730 information are stored. In an alternative embodiment, at state 825, the Auto-Dial Application 790 may send to the Telephony Subsystem 800 a request to establish a voice connection with the remote response agency.

At state 840, the Telephony Subsystem 800 retrieves the information identified by the Dial Entry. At state 850, the Telephony Subsystem 800 gathers the information relating to the active 9-1-1 emergency call, also referred to as the Caller Identification Display (CID). The CID may include the call notes for the active 9-1-1 call as well as the ANI and/or ALI data.

At state 860, the Telephony Subsystem 800 broadcasts to the Satellite Device Manager 770 of the desired Satellite Device 730 the data transfer request with the appropriate Dial Entry information and CID. At state 865, the Satellite Device Manager 770 receives the broadcast from the Telephony Subsystem 800.

At state 870, the appropriate Satellite Device Manager 770 performs the specific data transmission requested by the broadcast and at state 875 the Satellite Device 730 receives the data transmission. The method then ends at state 880.

Once the voice and data is received at the CTI workstation, a user at the CTI workstation may add to the data. For example, in an exemplary embodiment, a user at a CTI workstation may receive ALI and/or ANI data from a 9-1-1 emergency call. The user at the CTI workstation may then add to those data specific facts regarding the emergency situation communicated from a caller. Moreover, the CTI workstation may add to the data contact information for a recipient, such as a remote response agency, where that recipient contact information may be used to communicate the emergency 9-1-1 call data to the remote response agency.

In state 535, the user at the CTI workstation initiates a remote transfer to a particular remote response agency or multiple agencies. The user may also select at state 535 what data is to be sent in the remote transfer. For example, if a TTY conversation takes place, the text of the TTY conversation can be sent in the remote transfer. Also, ALI data, ANI data, call history, call notes, or other supplemental information may be sent in the remote transfer.

In state 540, the CTI workstation sends the selected data in digital format via a LAN or WAN to software within a server. The software may be the VRPU and the server may be a VESTA Server. At state 550, the software receives the digital data and formats it such that it may be communicated to the particular remote response agency chosen by the user at the CTI workstation. Depending on the particular remote agency chosen as the recipient of the data, the data may be formatted into a serial format for receipt by a serial terminal or a serial printer over a dedicated serial circuit, or the data may be formatted into an analog format for receipt by a fax machine over a PSTN, or the data may be formatted into a digital format for receipt by a remote workstation over a LAN or WAN.

The software may then communicate the formatted data to the chosen remote response agency. For example, at state 560, the software may send formatted data over a link to a serial recipient; at state 570 the software may send formatted data over a PSTN to a fax recipient; at state 580 the software may send formatted data over a LAN or WAN to a workstation recipient, such as a VESTA Satellite Workstation.

At state 590, the recipient may then receive the data and display it via the receiving device, for example, a fax, printer, terminal or workstation. In other embodiments, monitoring algorithms may be added to the CTI workstation and/or VRPU wherein a state of the connection (including serial, analog, digital or PSTN connections), the remote device (including terminals, fax machines, printers, and workstations), or transmission properties of the data may be monitored. For example, if the device of the recipient or the link is not working properly, a message may be delivered to the user at the CTI workstation. During, before, or after transmitting the data to the recipient, a user at the CTI workstation may establish a voice connection with the recipient at state 600. The method then ends at state 610.

As used herein, the term 9-1-1, including 9-1-1 call system, 9-1-1 communication system, 9-1-1 emergency system, and the like, refer to all types of emergency communication systems, inputs, and information, wherein emergency information, including voice and/or data, may be communicated to an appropriate response agency. Moreover, although various embodiments have illustrated 9-1-1 call processing systems, the invention is not limited to the 9-1-1 context. The apparatus and methods described in the various embodiments may be utilized in any context that may benefit from the flexibility of being able to receive data in a digital format and then process and communicate that data in an analog format.

The terms CTI system, CTI client, CTI server, digital, serial and analog have been used herein and are each defined in a broadest sense of their respective ordinary meanings. For example, although some embodiments depict a CTI system in the context of a 9-1-1 call distribution system, the invention contemplates any CTI system configured as claimed. Moreover, although various embodiments depict a CTI client as a VESTA workstation or depict a CTI server as a MAARS unit, PALLAS unit, or VESTA Server, the present invention contemplates any CTI server configured as claimed. Also, the term data is defined in a broadest sense of its ordinary meaning. Although in various embodiments the term data has been used in the context of ANI or ALI data, the present invention contemplates all data, including but not limited to TTY, call notes, supplemental information, and call history for both an active 9-1-1 call and previous 9-1-1 calls.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the invention may be embodied within a form that does not provide all of the features and benefits set forth herein, as some features may be used or practiced separately from others.

What is claimed is:

1. A computer-telephony integrated (CTI) system, comprising:
a first device configured to transmit first digital data and first formatting instructions corresponding to the first digital data, wherein the first formatting instructions specify either digital or analog format; and
a second device configured to receive the first digital data and first formatting instructions transmitted from the first device, the second device configured to format the first digital data according to the first formatting instructions.

2. The CTI system of claim 1, wherein the digital format comprises a Transmission Controlled Protocol (TCP) or an Internet Protocol (IP) format.

3. The CTI system of claim 2, wherein the second device is configured to transmit the formatted data over at least one of the following: a serial link, a wide area network, a local area network, and a publicly switched telephone network.

4. The CTI system of claim 3, wherein the second device is configured to transmit the formatted data to at least a third device, the third device located separate from the first and second devices, the third device comprising at least one of the following: a terminal, a printer, a fax machine, and a workstation.

5. The CTI system of claim 4, wherein the data transmitted to the third device corresponds to a 9-1-1 emergency call and comprises at least one of the following: automatic location information (ALI), call notes, call history, teletype data (TTY), and supplemental call information.

6. A method of transmitting data, comprising:
receiving data at a computer-telephony integrated (CTI) client that is transmitted from a communication source;
transmitting the data and formatting instructions for the data from the CTI client to a CTI server, wherein the formatting instructions comprise a particular format, the particular format comprising either analog or digital format;
formatting the transmitted data into the particular format; and
transmitting the formatted data to a remote device, wherein the remote device is at a location separate from the CTI client and CTI server.

7. The method of claim 6, wherein the digital format comprises a Transmission Controlled Protocol (TCP) or an Internet Protocol (IP) format.

8. The CTI system of claim 7, wherein the CTI server is configured to transmit the formatted data over at least one of the following: a serial link, a wide area network, a local area network, and a publicly switched telephone network.

9. The CTI system of claim 8, wherein the remote device comprises at least one of the following: a terminal, a printer, a fax machine, and a workstation.

10. The CTI system of claim 9, wherein the data transmitted to the remote device corresponds to a 9-1-1 emergency call and comprises at least one of the following: automatic location information (ALI), call notes, call history, teletype data (TTY), and supplemental call information.

11. The method of claim 6, further comprising adding additional information to the data prior to transmitting the data and formatting instructions for the data from the CTI client to a CTI server.

12. An apparatus for communicating data within a telecommunication system, comprising:
means for receiving data in a digital format;
means for formatting the data pursuant to formatting instructions; and
means for transmitting the formatted data to a remote device.

13. The apparatus of claim 12, wherein the digital format comprises a Transmission Controlled Protocol (TCP) or an Internet Protocol (IP) format.

14. The apparatus of claim 13, wherein the means for receiving data in a digital format comprises a VESTA Server.

15. The apparatus of claim 14, wherein the means for formatting the data pursuant to formatting instructions comprises a Virtual Remote Print Unit.

16. The apparatus of claim 15, wherein means for transmitting the formatted data to a remote device comprises at least one of the following: a serial link, a wide area network, a local area network, and a publicly switched telephone network.

17. A method of communicating data within a telecommunication system, comprising:
receiving first data at a first device;
retrieving second data at a second device, wherein the first data corresponds to the second data and the second data comprises formatting instructions, wherein the formatting instructions specify either digital or analog format;
transmitting the first and second data to a third device;
formatting the first data with the third device, wherein the first data is formatted into a format corresponding to the formatting instructions of the second data; and
transmitting the formatted data to a fourth device.

18. The method of claim 17, wherein the first device comprises a VESTA workstation and the first data comprises automatic number identification (ANI).

19. The method of claim 18, wherein the second device comprises an Auto-Dial Application and the second data comprises an Auto-Dial Entry.

20. The method of claim 19, wherein the third device comprises a Satellite Device Manager.

21. The method of claim 20, wherein the fourth device comprises at least one of the following: a terminal, a printer, a fax machine, and a workstation.

22. The method of claim 21, wherein the digital format comprises a Transmission Controlled Protocol (TCP) or an Internet Protocol (IP) format.

23. The method system of claim 22, wherein a VESTA Server comprises the Satellite Device Manager, wherein the VESTA Server transmits the formatted data to the fourth device, the fourth device being at a location separate from the VESTA Server.

24. The method of claim 23, wherein the VESTA Server is configured to transmit the formatted data over at least one of the following: a serial link, a wide area network, a local area network, and a publicly switched telephone network.

25. The method of claim 24, wherein the data transmitted to the fourth device corresponds to a 9-1-1 emergency call and comprises at least one of the following: automatic location information (ALI), call notes, call history, teletype data (TTY), and supplemental call information.

26. A method of communicating within a 9-1-1 communication system, the method comprising:
receiving 9-1-1 information at a central office;
deciding an appropriate routing for the 9-1-1 information;
selecting at least a portion of the 9-1-1 information for routing to a response agency;
sending the selected portion of the 9-1-1 information to an output device;
formatting into a transmission type the selected portion of the 9-1-1 information at the output device, wherein the transmission type corresponds to at least one communication device at the response agency; and
transmitting in the transmission type the formatted 9-1-1 information to the at least one communication device at the response agency.

27. The method of claim 26, further comprising adding at least one of the following data to the 9-1-1 call information prior to transmitting the 9-1-1 call information to the at least one communication device at the response agency: automatic location information (ALI), call notes, call history, teletype data (TTY), and supplemental call information.

28. The method of claim 27, wherein selecting at least a portion of the 9-1-1 information for routing to a response agency comprises an automatic selection of the at least one communication device at the response agency for receipt of the transmitted 9-1-1 information.

29. The method of claim 28, wherein sending the selected portion of the 9-1-1 information to an output device comprises sending format information corresponding to the automatically selected at least one communication device at the response agency.

30. The method of claim 28, wherein formatting into a transmission type the selected portion of the 9-1-1 information at the output device comprises automatically retrieving formatting information for the at least one communication device at the response agency.
